(19) United States
(12) Patent Application Publication
(10) Pub. No.: US 2019/0311387 A1
(43) Pub. Date: Oct. 10, 2019

(54) COMPUTER SYSTEM, VACANT SEAT DETECTING METHOD, AND PROGRAM

(71) Applicant: OPTiM Corporation, Saga-shi (JP)

(72) Inventor: Shunji SUGAYA, Tokyo (JP)

(21) Appl. No.: 15/575,905

(22) PCT Filed: Dec. 21, 2016
(86) PCT No.: PCT/JP2016/088004

§ 371 Date: Nov. 21, 2017

(51) Int. Cl. G06Q 30/02; G06K 9/00; G06T 7/70

(52) U.S. Cl. CPC G06Q 30/0223; G06Q 30/0202; G06T 2207/30196; G06T 7/70; G06T 2207/30242; G06K 9/00624

(57) ABSTRACT

A computer system for detecting vacant seats and providing a coupon acquires a camera image; detects vacant seats by performing an image analysis on the acquired camera image, issues a coupon based on a result of the detection, and provides the issued coupon. Further, the computer system issues the coupon in which a discount rate by the coupon changes according to a number of the vacant seats or a ratio of the vacant seats. Furthermore, the computer system issues the coupon in which a discount rate by the coupon changes according to a time it takes a customer who has been provided with the coupon enters a store. In addition, the computer system forecasts a number of vacant seats in a time period of a case where the coupon is provided and a sales amount changed by providing the coupon.

### TECHNICAL FIELD

The present invention relates to a computer system, a vacant seat detecting method, and a program that detect vacant seats and provides a coupon.

### BACKGROUND ART

In recent years, there is a system which provides various sensors such as a weight sensor are provided in a chair in a public transportation facility, a restaurant or the like, and determines whether this chair is vacant from the detection result of the sensors. In such a system, it is possible to notify vacant seat information to a customer by transmitting the determination result to a customer terminal or the like possessed by the customer.

In such a vacant seat detecting system, a management device transmits a measurement instruction to various sensors, and various sensors transmit to the management device a detection result which is detected based on this instruction. The management device determines whether a seat is vacant based on this detection result, and transmits a position of the vacant seat to the terminal (see Patent Document 1).

### PRIOR ART DOCUMENT

### Patent Document

Patent Document 1: Japanese Patent Application Publication No. 2013-222358

### SUMMARY OF THE INVENTION

### Technical Problem

However, in the configuration of Patent Document 1, although it is possible to detect the vacant seats, no benefit is provided to users in order to fill the vacant seats. Therefore, information on the detected vacant seats cannot be tied to attract the customers.

It is an object of the present invention to provide a computer system, a vacant seat detecting method, and a program for improving a possibility of attracting customers by detecting vacant seats and providing coupons that are advantageous to the customers.

### Technical Solution

The present invention provides the following solutions.

The present invention provides a computer system for detecting vacant seats and providing a coupon. The computer system includes an acquiring unit that acquires a camera image, a detecting unit that detects vacant seats by performing an image analysis on the acquired camera image, an issuing unit that issues a coupon based on a result of the detection, and a providing unit that provides the issued coupon.

According to the present invention, a computer system for detecting vacant seats and providing a coupon acquires a camera image, detects vacant seats by performing an image analysis on the acquired camera image, issues a coupon based on a result of the detection, and provides the issued coupon.

The present invention relates to a computer system, but exhibits the same operations and effects even when being applied to other categories such as a vacant seat detecting method, a program, and the like.

### Effects of the Invention

According to the present invention, it is possible to provide a computer system, a vacant seat detecting method, and a program for improving a possibility of attracting customers by detecting vacant seats and providing coupons that are advantageous to the customers.

### BRIEF DESCRIPTION OF THE DRAWINGS

FIG. 1 is a diagram for explaining an overview of a vacant seat detecting system 1.

FIG. 2 is a diagram showing a system configuration of a vacant seat detecting system 1.

FIG. 3 is a functional block diagram of a computer 10, a camera 100, and a customer terminal 200.

FIG. 4 is a diagram showing a flowchart of an imaging process executed by a computer 10 and a camera 100.

FIG. 5 is a flowchart showing a vacant seat detecting process executed by a computer 10.

FIG. 6 is a flowchart showing a vacant seat detecting process executed by a computer 10.

FIG. 7 is a flowchart showing a coupon providing process executed by a computer 10 and a customer terminal 200.

FIG. 8 is a flowchart showing a coupon providing process executed by a computer 10 and a customer terminal 200.

FIG. 9 is a diagram showing an example of a result of an image analysis.

FIG. 10 is a diagram showing an example of a result of an image analysis.

FIG. 11 is a diagram showing an example of a first discount constant database.

FIG. 12 is a diagram showing an example of a probability database.

FIG. 13 is a diagram showing an example of a second discount constant database.

FIG. 14 is a diagram showing an example of a coupon acquisition screen displayed by a display module 270.

### DETAILED DESCRIPTION OF THE EMBODIMENTS

Hereinafter, embodiments for carrying out the present invention are described with reference to the drawings. It is to be understood that the embodiments are merely examples and the scope of the present invention is not limited to the disclosed embodiments.

[Overview of Vacant Seat Detecting System 1]

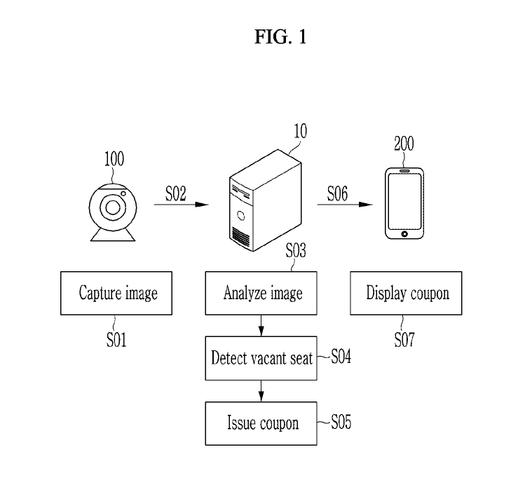

An overview of the present invention is described with reference to FIG. 1. FIG. 1 is a diagram for explaining an overview of a vacant seat detecting system 1 which is an embodiment of the present invention. The vacant seat detecting system 1 includes a computer 10, a camera 100, and a customer terminal 200, and is a computer system that detects vacant seats and provides a coupon.

In FIG. 1, the number of computer(s) 10, the number of camera(s) 100, and the number of customer terminal(s) 200 may be appropriately changed. In addition, the computer 10, the camera 100, and the customer terminal 200 are not limited to existing devices, and may be virtual devices. Further, each process to be described below may be realized by any one or a combination of two or more of the computer 10, the camera 100, and the customer terminal 200.

The computer 10 is a computer device capable of performing data communication with the camera 100 and the customer terminal 200.

The camera 100 is an imaging device such as a network camera, capable of performing data communication with the computer 10. The camera 100 is provided inside a store such as a restaurant, and captures a table, a chair, a customer, and the like in the store as a camera image such as a moving image or a still image. In addition, the camera 100 may be provided in other places than the store.

The customer terminal 200 is a terminal device possessed by a customer and can perform data communication with the computer 10. The customer terminal 200 is, for example, an electric appliance such as a mobile phone, a portable information terminal, a tablet terminal, a personal computer, a netbook terminal, a slate terminal, an electronic dictionary terminal, a portable music player, or the like, a wearable terminal such a smart glasses, a head mounted display or the like, and other goods.

First, the camera 100 captures an image in the store (step S01). The camera 100 captures an image of tables, chairs belonging to the tables, and customers sitting on the chairs as a camera image.

The camera 100 transmits the captured camera image to the computer 10 (step S02).

The computer 10 receives the camera image. The computer 10 acquires the camera image captured by the camera 100 by receiving the camera image.

The computer 10 performs an image analysis on the camera image (step S03). The computer 10 analyzes positions and the number of tables, positions and the number of chairs belonging to each table, positions and the number of customers, and the like.

The computer 10 detects vacant seats based on the result of the image analysis (step S04). The computer 10 detects the vacant seats by judging that the customer is not seated in the chair, that no goods are placed on the table, or the goods are not placed on the chair belonging to this table, or the like.

The computer 10 issues a coupon based on the detected result (step S05). The computer 10 issues the coupon whose discount rate is changed according to the number of detected vacant seats, a ratio of detected vacant seats or the time until the customer enter the store. For example, the computer 10 issues the coupon with higher discount rate as the number of vacant seats is larger, the coupon with higher discount rate as the time to enter the store is shorter, or the coupon in which these are combined.

The computer 10 transmits the issued coupon to the customer terminal 200 (step S06). The computer 10 provides this coupon by transmitting the issued coupon to the customer terminal 200.

The customer terminal 200 receives the coupon. The customer terminal 200 displays the received coupon (step S07).

The above is the outline of the vacant seat detecting system 1.

[System Configuration of Vacant Seat Detecting System 1]

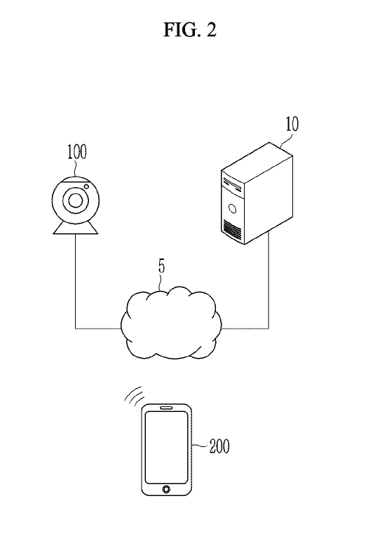

A system configuration of a vacant seat detecting system 1 is described with reference to FIG. 2. FIG. 2 is a diagram showing a system configuration of a vacant seat detecting system 1 which is an embodiment of the present invention. The vacant seat detecting system 1 includes a computer 10, a camera 100, a customer terminal 200, a public line network 5 (an Internet network, a third or fourth generation communication network, etc.). The vacant seat detecting system 1 detects vacant seats and provides a coupon.

The number and types of devices constituting the vacant seat detecting system 1 may be appropriately changed. In addition, the vacant seat detecting system 1 may be realized not only by existing devices but also by virtual devices. Further, each process to be described below may be realized by any one or a combination of two or more of devices constituting the vacant seat detecting system 1.

The computer 10 is the above-described computer device having functions to be described below.

The camera 100 is the above-described imaging device having functions to be described below.

The customer terminal 200 is the above-described terminal device having functions to be described below.

[Description of Each Function]

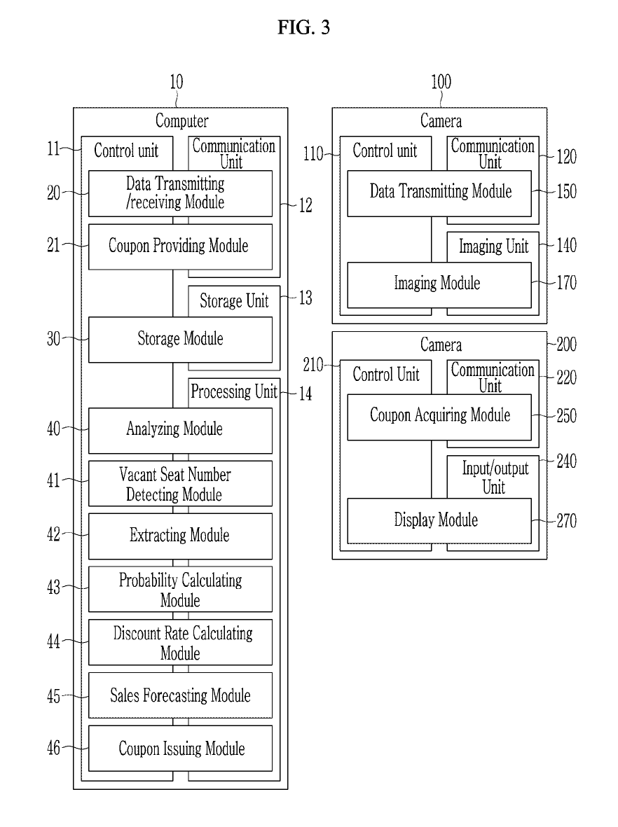

Functions of a vacant seat detecting system 1 are described with reference to FIG. 3. FIG. 3 is a functional block diagram of a computer 10, a camera 100, and a customer terminal 200.

The computer 10 includes, as a control unit 11, a CPU (Central Processing Unit), a RAM (Random Access Memory), a ROM (Read Only Memory), and the like. The computer 10 includes, as a communication unit 12, a device, for example a WiFi (Wireless Fidelity) compliant device conforming to IEEE 802.11 or the like, for enabling communication with other devices. In addition, the computer 10 includes, as a storage unit 13, a data storage device such as a hard disk, a semiconductor memory, a recording medium, a memory card, or the like. Further, the computer 10 includes, as a processing unit 14, an analysis device for executing an image analysis of the acquired camera image, an issuing device for issuing a coupon, a calculation device for executing various calculations, and the like.

In the computer 10, the control unit 11 reads a predetermined program, thereby realizing a data transmitting/receiving module 20 and a coupon providing module 21, in cooperation with the communication unit 12. In addition, in the computer 10, the control unit 11 reads a predetermined program, thereby realizing a storage module 30 in cooperation with the storage unit 13. Further, in the computer 10, the control unit 11 reads a predetermined program, thereby realizing an analyzing module 40, a vacant seat number detecting module 41, an extracting module 42, a probability calculating module 43, a discount rate calculating module 44, a sales forecasting module 45, and a coupon issuing module 46, in cooperation with the processing unit 14.

Like the computer 10, the camera 100 includes, as a control unit 110, a CPU, a RAM, a ROM, and the like, and includes, as a communication unit 120, a device that enables communication with other devices. In addition, the camera 100 includes, as an imaging unit 140, an imaging device including a lens, an image pickup device, various buttons, a flash, and the like.

In the camera 100, the control unit 110 reads a predetermined program, thereby realizing a data transmitting module 150 in cooperation with the communication unit 120. In addition, in the camera 100, the control unit 110 reads a predetermined program, thereby realizing an imaging module 170 in cooperation with the imaging unit 140.

Like the computer 10, the customer terminal 200 includes, as a control unit 210, a CPU, a RAM, a ROM, and the like, and includes, as a communication unit 220, a device that enables communication with other devices. In addition, the customer terminal 200 includes, as an input/output unit 240, a display unit that outputs and displays data and images controlled by the control unit 210, an input unit such as a touch panel, a keyboard, a mouse, and the like for receiving an input from a customer terminal.

In the customer terminal 200, the control unit 210 reads a predetermined program, thereby realizing a coupon acquiring module 250 in cooperation with the communication unit 220. In addition, in the customer terminal 200, the control unit 210 reads a predetermined program, thereby realizing a display module 270 in cooperation with the input/output unit 240.

In the following description, it is assumed that one camera 100 and one customer terminal 200 are provided, but this process can be executed even if there are a plurality of cameras 100 or customer terminals 200.

[Imaging Process]

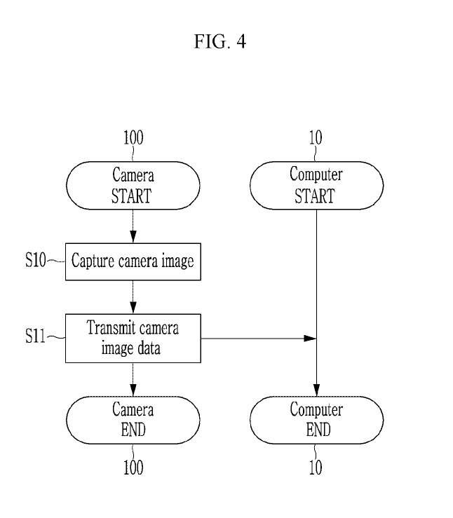

An imaging process executed by a vacant seat detecting system 1 is described with reference to FIG. 4. FIG. 4 is a diagram showing a flowchart of an imaging process executed by a computer 10 and a camera 100. The process executed by modules of each device described above is described in conjunction with the present process.

An imaging module 170 captures a camera image such as a moving image or a still image in a store such as a restaurant (step S10). In step S10, the imaging module 170 images the camera image at all times. The camera 100 is installed at a position where the inside of the store can be seen, and images all the tables existing in the store and chairs belonging to each table.

In step S10, a plurality of cameras 100 may be provided in the store, and each camera 100 may capture the camera image of one or more corresponding tables and chairs belonging to each table. Further, the imaging module 170 may capture the camera image at predetermined time intervals, for example, every thirty seconds, every minute, every five minutes, or the like.

A data transmitting module 150 transmits a camera image data indicating the camera image to a computer 10 (step S11). In step S11, the data transmitting module 150 adds an identifier (such as a name of an installation place, location information of the installation place, an equipment number, a prefixed number, an IP address, a MAC address, or the like) on an imaging place as an equipment data.

The data transmitting/receiving module 20 receives the camera image data. The computer 10 acquires the camera image captured by the camera 100 by receiving the camera image data.

The above is the imaging process.

[Vacant Seat Detecting Process]

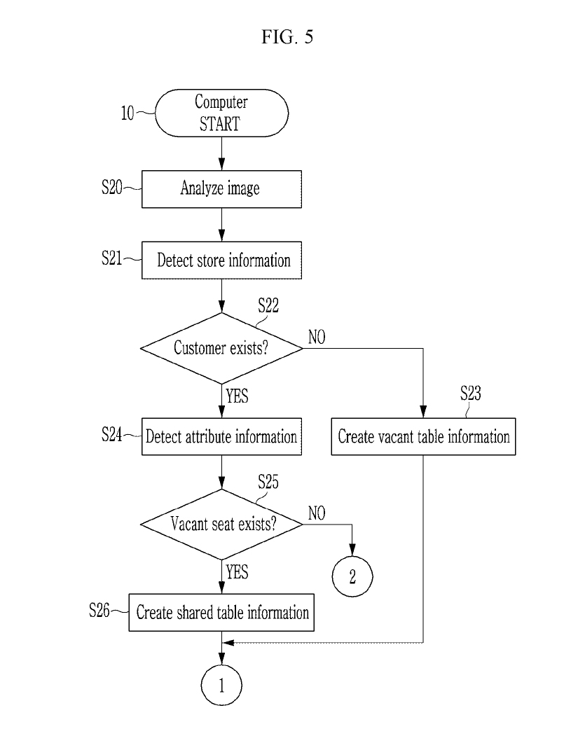

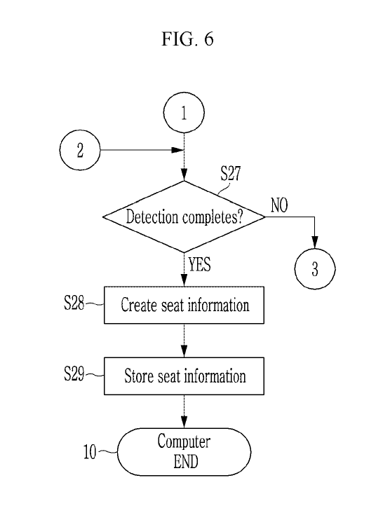

A vacant seat detecting process executed by a vacant seat detecting system 1 is described with reference to FIG. 5 and FIG. 6. FIG. 5 and FIG. 6 are flowcharts showing a vacant seat detecting process executed by a computer 10. The process executed by each module described above is described in conjunction with the present processing.

An analyzing module 40 performs an image analysis one the acquired camera image (step S20). In step S20, the analyzing module 40 calculates the positions and the number of tables appearing in the camera image, the positions and the numbers of chairs belonging to each table, the positions and the number of customers, and the food placed on the table. For example, the analyzing module 40 analyzes the tables, the chairs, and the customers by extracting the feature amount of the camera image. Further, based on the analysis result, the analyzing module 40 determines the vacant seat status of the tables, the number of customers, the order contents of the customers, and the like.

Furthermore, the analyzing module 40 may store in advance a camera image acquired by imaging the positions and the number of tables and the position and the number of chairs belonging to each table in a state where no customer at this store is present, and compare the camera image acquired this time with the stored camera image to perform the image analysis. Further, the analyzing module 40 may perform the image analysis by other methods.

Based on the result of the image analysis, the analyzing module 40 detects store information indicating the positions and the number of tables appearing in the camera image and the positions and the number of chairs belonging to each table (step S21). In step S21, the analyzing module 40 detects the positions and the number of tables appearing in the camera image. In addition, the analyzing module 40 detects the positions and the number of chairs belonging to each table appearing in the camera image. When the analyzing module 40 detects a circular or rectangular table, the analyzing module 40 detects chairs existing around the table as chairs belonging to this table. In addition, the analyzing module 40 detects the rectangular table and detects chairs that exist at positions opposed to each other with the table as chairs belonging to this table. Further, the analyzing module 40 detects the rectangular table and detects chairs arranged along one side as a group of chairs belonging to this table. Furthermore, the analyzing module 40 detects the rectangular table and detects chairs arranged along one side as chairs of different groups belonging to this table. The analyzing module 40 may detect chairs belonging to each table by configuration other than the above examples.

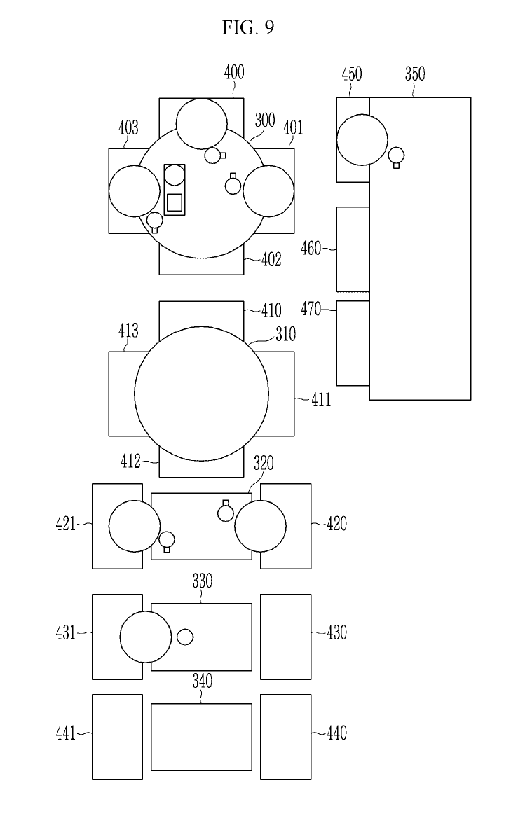

The result of the image analysis executed by the analyzing module 40 is described with reference to FIG. 9. FIG. 9 is a diagram showing an example of the result of the image analysis. In FIG. 9, the analyzing module 40 detects the positions and the number of tables appearing in the camera image and the positions and the number of chairs belonging to each table. In other words, the analyzing module 40 detects a first table 300, a second table 310, a third table 320, a fourth table 330, a fifth table 340, and a sixth table 350, as tables shown in the camera image. Further, the analyzing module 40 detects chairs 400 to 403 belonging to the first table 300, chairs 410 to 413 belonging to the second table 310, chairs 420 and 421 belonging to the third table 320, chairs 430 and 431 belonging to the fourth table 330, chairs 440 and 441 belonging to the fifth table 340, and chairs 450, 460, and 470 belonging to the sixth table 350.

The analyzing module 40 determines which chair belongs to which table based on the shape of each chair and the position of each chair, and detects chairs belonging to each table. For example, when the table has a circular shape, the analyzing module 40 detects chairs positioned around the circle as the chairs belonging to this table. Further, when the table has a rectangular shape, the analyzing module 40 detects chairs arranged at the surrounding position or the opposing position as the chairs belonging to this table. Furthermore, when the table is the rectangular shape, the analyzing module 40 detects chairs arranged to one side of the rectangle as the chairs of different groups belonging to this table. In FIG. 9, the chairs belonging to each table are handled as one group in the first to fifth tables 300 to 340, but the chairs 450, 460, and 470 are handled as the different groups in the sixth table 350.

Based on the result of the image analysis, the analyzing module 40 determines whether a customer exists in the detected chair (step S22). In step S22, the analyzing module 40 determines whether the customer exists in one or more of the chairs belonging to one table. The analyzing module 40 determines whether the customer exists in one or more of chairs belonging to each table. When the customer is imaged to be superimposed on the chair, the analyzing module 40 determines that the customer exists. Further, when food or the other item is placed on the table, the analyzing module 40 determines that the customer exists in any one of the chairs in this table. Furthermore, when an item is placed on the chair, the analyzing module 40 determines that the customer exists in another chair of the table to which this chair belongs or in this chair.

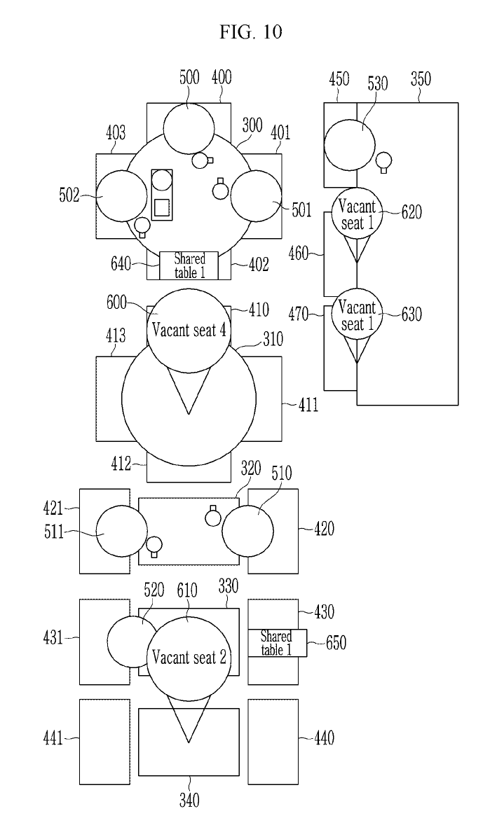

In step S22, when the analyzing module 40 determines that there is no customer (NO in step S22), that is, when all the chairs belonging to one table are vacant, the analyzing module 40 creates vacant table information (Step S23). In step S23, the analyzing module 40 creates an identifier of the table and the number of vacant chairs as vacant table information. The identifier of the table is a character string set in each table in advance, position information, or the like. For example, in FIG. 10, the analyzing module 40 creates, as the vacant table information, the identifier of the second table 310 and a fact that the four chairs 410 to 413 are vacant. In addition, the analyzing module 40 creates, as the vacant table information, the identifier of the fifth table 340 and a fact that two chairs 440 and 441 are vacant. Further, the analyzing module 40 creates, as the vacant table information, the identifier of the sixth table 350 and a fact that one chair 620 is vacant. Furthermore, the analyzing module 40 creates, as the vacant table information, the identifier of the sixth table 350 and a fact that one chair 630 is vacant.

In step S23, for a store in which no table exists, the analyzing module 40 may create a vacant chair as vacant table information.

On the other hand, when determining in step S22 that there is a customer (YES in step S22), the analyzing module 40 detects attribute information of the customer existing in this chair (step S24). In step S24, the analyzing module 40 detects, as the attribute information, an entering time, a staying time, the order contents, a purchase price of the customer, or the like. The analyzing module 40 detects the attribute information based on food that is placed on the table belonging to the chair in which the customer exists, a time when this customer is detected for the first time, the entering time, the order contents, or the like. The analyzing module 40 extracts the feature amount of the food placed on the table based on the result of the image analysis. The analyzing module 40 specifies the order contents ordered by the customer based on the extracted feature amount. The analyzing module 40 specifies the purchase price of this customer based on a tariff or the like associated with the order contents. Further, the analyzing module 40 specifies, as the entering time, the time when it is first detected that the customer exists in the chair. Furthermore, the analyzing module 40 specifies a time between the entering time and the current time as the staying time.

The attribute information detected by the analyzing module 40 is not limited to the above-described configuration, and other information may be detected, or any of them may be used. Further, this process may be omitted, and in this case, each process described below may be executed. Furthermore, the data transmitting/receiving module 20 may be configured to transmit the attribute information to a store terminal (not shown). By doing this, it becomes easy for the store terminal to grasp the unit price of the customer, the staying time of the customer, the order contents of the customer, and the like, and it becomes easy for the store terminal to calculate the sales amount to be described below.

The result of the image analysis executed by the analyzing module 40 is described with reference to FIG. 10. FIG. 10 is a diagram showing an example of the result of the image analysis. The analyzing module 40 detects presence/absence of a customer in each table and the attribute information of the customer.

The analyzing module 40 detects three customers 500 to 502 in the first table 300. In the first table 300, the analyzing module 40 detects the customer 500 in the chair 400, the customer 501 in the chair 401, the customer 502 in the chair 403, and no customer in the chair 402. The analyzing module 40 detects that the chair 402 in which no customer exists is a vacant seat but is a shared table because there are other customers, and displays a shared table icon 640 indicating that one chair is vacant by superimposing the shared table icon 640 on the chair 402. The shared table icon 640 indicates the number of vacant seats. Further, the analyzing module 40 detects the attribute information of the first table 300, and detects the staying time and the order contents.

The analyzing module 40 detects that there is no customer in the second table 310. Since there is no customer in the chairs 410 to 413 of the second table 310, the analyzing module 40 detects that the second table 310 in which there is no customer has vacant seats, and displays a vacant seat icon 600 by superimposing the vacant seat icon 600 on the second table 310. The number of chairs 410 to 413 belonging to this second table 310 is displayed on the vacant seat icon 600.

The analyzing module 40 detects two customers 510 and 511 in the third table 320. In the third table 320, the analyzing module 40 detects the customer 510 in the chair 420 and the customer 511 in the chair 421. The analyzing module 40 detects that the third table 320 is full because there is no chair in which there is no customer. The analyzing module 40 detects the attribute information of the third table 320, and detects the staying time and the order contents.

The analyzing module 40 detects one customer 520 in the fourth table 330. In the fourth table 330, the analyzing module 40 detects no customer in the chair 430 and the customer 520 in the chair 431. The analyzing module 40 detects that the chair 430 in which the customer does not exist is a vacant seat but is a shared table because there is another customer, and displays a shared table icon 650 indicating that one chair is vacant by superimposing the shared table icon 650 on the chair 430. The shared table icon 650 indicates the number of vacant seats. In addition, the analyzing module 40 detects the attribute information of the fourth table 330, and detects the staying time and the order contents.

The analyzing module 40 detects that there is no customer in the fifth table 340. In the fifth table 340, since no customer exists in the chairs 440 and 441, the analyzing module 40 detects that the fifth table 340 in which no customer exists is vacant, and superimposes a vacant seat icon 610 on this fifth table 340 and display it. The vacant seat icon 610 displays the number of chairs 440 and 441 belonging to the fifth table 340.

The analyzing module 40 detects one customer 530 in the sixth table 350. In the sixth table 350, the analyzing module 40 detects the customer 530 in the chair 450, no customer in the chair 460, and no customer in the chair 470. Since the chairs are arranged along only one side in the sixth table 350, the analyzing module 40 detects that each chair is an independent chair, and detects that the chair 450 is full, the chair 460 is vacant, and the chair 470 is vacant. The analyzing module 40 detects the attribute information of the chair 450, and detects the staying time and the order contents. The analyzing module 30 displays a vacant seat icon 620 similar to those of the second table 310 and the fifth table 340 by superimposing the vacant seat icon 620 on the chair 460, and displays a similar vacant seat icon 630 by superimposing the vacant seat icon 630 on the chair 470. The number of chairs 460 is displayed on the vacant seat icon 640. Further, the number of the chairs 470 is displayed on the vacant seat icon 640.

The analyzing module 40 may be configured to superimpose vacant seat icons on all the vacant seats. Further, a vacant seat may be indicated by other configurations. Furthermore, vacant seat icons may be superimposed on all the tables in which vacant seats exist.

The analyzing module 40 determines whether there is a vacant seat (step S25). In step S24, the analyzing module 40 determines whether there is a vacant seat in chairs belonging to one table. The analyzing module 40 determines whether there is a chair in which a customer is not detected among chairs located around or near one table.

In step S25, when determining that there is no vacant seat (NO in step S25), the analyzing module 40 executes a process of step S27 to be described below.

On the other hand, in step S25, when the analyzing module 40 determines that there is a vacant seat (YES in step S25), that is, when a customer exists in other chairs of a table to which a chair that is a vacant seat belongs, the analyzing module 40 determines that this table is a shared table and creates shared table information (step S26). In step S26, the analyzing module 40 creates an identifier of the table and the number of vacant chairs as the shared table information. The identifier of the table is a character string set in each table in advance, position information, or the like. For example, in FIG. 10, the analyzing module 40 creates, as the shared table information, that the identifier of the first table 300 and a fact that one chair 402 is vacant. In addition, the analyzing module 40 creates, as the shared table information, the identifier of the fourth table 330 and a fact that one chair 430 is vacant.

The analyzing module 40 determines whether detection on all the tables appearing in the camera image, the chairs and customers belonging to each table has been completed (step S27). In step S27, when determining that it has not been completed (NO in step S27), the analyzing module 40 executes the process from step S22 again.

On the other hand, when the analyzing module 40 determines in step S27 that it has been completed (YES in step S27), the analyzing module 40 creates seat information by collecting the attribute information, the shared table information, and the vacant seat information (step S28). In step S28, the analyzing module 40 creates the seat information based on the attribute information, the shared table information, and the vacant seat information in each table. In addition to these, the seat information may include a shared table status of each table, a status such as a ratio of total seats and vacant seats, the attribute information of each customer, an expected remaining time in the staying time of the customer, and the like. The analyzing module 40 learns the order contents and the staying times of the past customers as teacher data, and calculates the expected remaining time in the staying time based on the order contents included in the attribute information detected this time.

A storage module 30 stores the seat information (step S29). In step S29, the storage module 30 stores an identifier (a store name, a preset character string, an address, location information, etc.) of the store, a current time, and the seat information in association with each other. Further, the storage module 30 may store items other than those described above in association with the seat information, or may store only the seat information.

The above is the vacant seat detecting process.

[Coupon Providing Process]

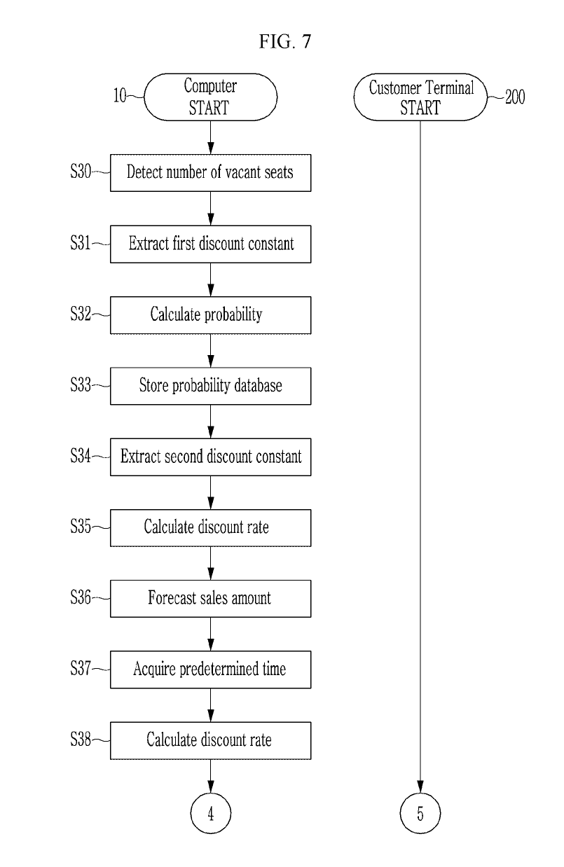

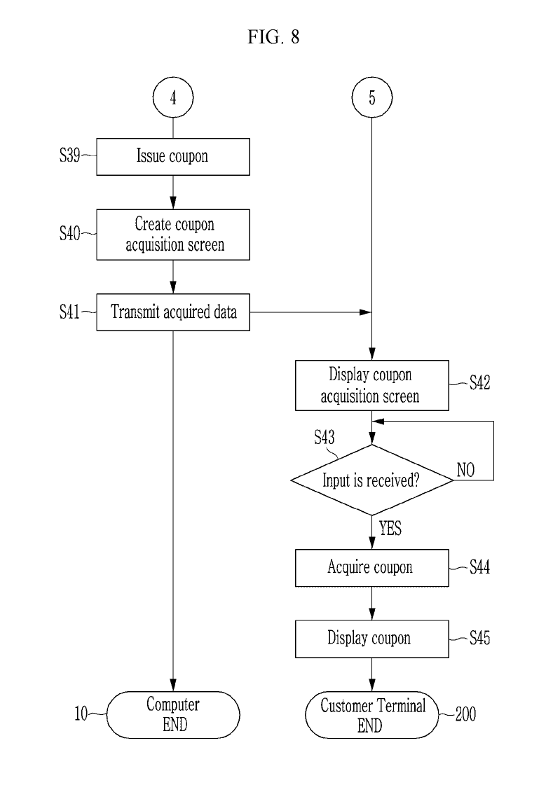

A coupon providing process executed by a vacant seat detecting system 1 is described with reference to FIG. 7 and FIG. 8. FIG. 7 and FIG. 8 are flowcharts showing a coupon providing process executed by a computer 10 and a customer terminal 200. The process executed by the modules of each device described above is described in conjunction with the present process.

A vacant seat number detecting module 41 detects the number of vacant seats based on seat information (step S30). In step S30, the vacant seat number detecting module 41 detects, as the number of vacant seats, each of the number of vacant seats based on vacant table information and the number of vacant seats based on the shared table information. The number of vacant seats based on the vacant table information is the number of chairs belonging to a table in which no customer exists, and the number of vacant seats based on the shared table information is the number of chairs which belongs to a table in which a customer exists but in which the customer belonging to this table does not exist.

The vacant seat number detecting module 41 may detect a ratio of the vacant seats based on seat information instead of the number of vacant seats. The vacant seat number detecting module 41 detects, as the ratio of vacant seats, each of the ratio of vacant seats based on the vacant table information and the ratio of vacant seats based on the shared table information. In this case, the computer 10 may execute a process to be described below based on the ratio of vacant seats instead of the number of vacant seats.

An extracting module 42 extracts a first discount constant by referring to a first discount constant database stored in a storage module 30 based on the detected number of vacant seats (step S31). In step S31, the extracting module 42 extracts the first discount constant based on the number of vacant seats which is based on the vacant table information. The extracting module 42 refers to the first discount constant database in which the number of vacant seats and a discount constant is associated with each other, and extracts the first discount constant based on the number of vacant seats which is based on the vacant table information.

Further, the extracting module 42 may extract the first discount constant based on the shared table information. In this case, a first discount constant similar to the above-described first discount constant database may be extracted, or a discount constant with a larger discount constant value may be extracted. Further, the extracting module 42 may extract the first discount constant based on the vacant table information and the shared table information.

[First Discount Constant Database]

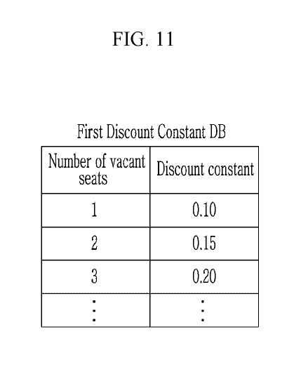

The first discount constant database stored in the storage module 30 is described with reference to FIG. 11. FIG. 11 is a diagram showing an example of the first discount constant database. In FIG. 11, the storage module 30 stores the number of vacant seats and the discount constant in association with each other. The number of vacant seats is the total number of chairs arranged in a table where no customer sits among chairs existing in the store. The discount constant has a predetermined value. The storage module 30 stores the number of vacant seats “1” and the discount constant “0.10” in association with each other, stores the number of vacant seats “2” and the discount constant “0.15” in association with each other, and stores the number of vacant seats “3” and the discount constant “0.20” in association with each other. The storage module 30 stores the number of vacant seats and the discount constant in association with each other as much as the number of chairs existing in the store. The storage module 30 may store the number of vacant seats and the discount constant which are set in advance. Alternatively, a store terminal or the like (not shown) may receive an input of the number of vacant seats and the discount constant, and the storage module 30 may acquire the received number of vacant seats and discount constant and store them. The values or contents of the number of vacant seats and the discount constant may be changed as appropriate.

A probability calculating module 43 calculates a probability in a case of providing a coupon based on data indicating that the vacant seat has been filled by providing the coupon in the past (step S32). In step S32, the probability calculating module 43 calculates the probability based on this data for every predetermined time (15 minutes, 30 minutes, 45 minutes, or etc.).

The storage module 30 stores the calculated probability as a probability database (step S33). In step S33, the storage module 30 stores the probability database in which a type of issued coupon and a probability that a vacant seat is filled after a predetermined time are associated with each other.

[Probability Database]

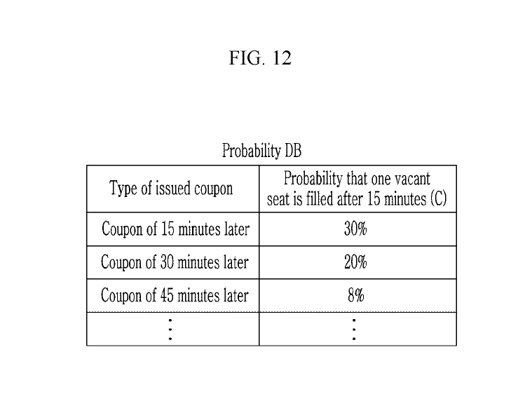

The probability database stored by the storage module 30 is described with reference to FIG. 12. FIG. 12 is a diagram showing an example of the probability database. In FIG. 12, the storage module 30 stores the type of issued coupon and the probability that one vacant seat is filled after 15 minutes in association with each other. The coupon type is a coupon to be provided to a customer who enters the store after a predetermined time. The probability that one vacant seat is filled after 15 minutes is the probability calculated in the process of step S32 described above. The storage module 30 stores the issued coupon type “coupon of 15 minutes later” and the probability “30%” that one vacant seat is filled after 15 minutes in association with each other, stores the issued coupon type “coupon of 30 minutes later” and the probability “20%” that one vacant seat is filled after 15 minutes in association with each other, and stores the issued coupon type “coupon of 45 minutes later” and the probability “8%” that one vacant seat is filled after 15 minutes in association with each other. Similarly, the storage module 30 stores a probability database that stores a probability that one vacant seat is filled after 30 minutes, and a probability database that stores a probability that one vacant seat is filled after 45 minutes. The issued coupon type is not limited to the time interval such as 15 minutes, 30 minutes, 45 minutes, or the like, and may be appropriately changed. Further, the probability calculated by the probability calculating module 30 is not limited to the time interval such as 15 minutes, 30 minutes, 45 minutes, or the like, and may be changed as appropriate.

The extracting module 42 extracts a second discount constant by referring to a second discount constant database stored in the storage module 30 based on a time with the highest probability in the above-described probability database (step S34). In step S34, the extracting module 42 extracts the second discount constant from the second discount constant database based on the time with the highest probability that the vacant seat is filled after the predetermined time.

In the case of each of the predetermined times (15 minutes, 30 minutes, and 45 minutes), the extracting module 42 may calculate the second discount constant for each of the predetermined times, based on the time with the highest probability. Further, the extracting module 42 may extract the second discount constants in all the times, respectively.

[Second Discount Database]

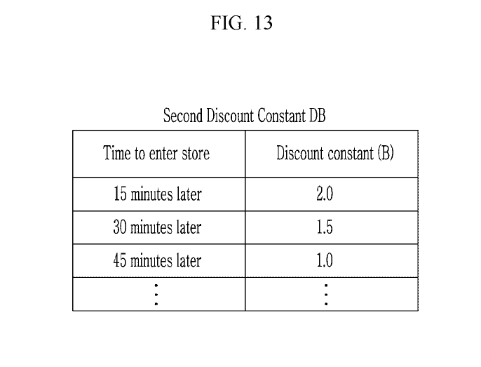

The second discount constant database stored in the storage module 30 is described with reference to FIG. 13. FIG. 13 is a diagram showing an example of the second discount constant database. In FIG. 13, the storage module 30 stores a time to enter a store and a discount constant in association with each other. The time to enter the store is a time it takes for a customer to enter the store after a coupon is provided. The discount constant has a predetermined value. The storage module 30 stores the time to enter the store “15 minutes later” and the discount constant “2.0” in association with each other, stores the time to enter the store “30 minutes later” and the discount constant “1.5” in association with each other, and stores the time to enter the store “45 minutes later” and the discount constant “1.0” in association with each other. In the second discount database, the shorter the time to enter the store, the larger the discount constant is set. The storage module 30 may store the time to enter the store and the discount constant which is set in advance. Alternatively, a store terminal (not shown) or the like may receive an input of the time to enter the store and the discount constant, and the storage module 30 may acquire the received time to enter the store and discount constant and store them. Further, the values of the time to enter the store and the discount constant may be changed as appropriate.

A discount rate calculating module 44 calculates a discount rate of the coupon based on the first discount constant and the second discount constant described above (step S35). In step S35, the discount rate calculating module 44 calculates the discount rate from a product of the first discount constant and the second discount constant. For example, when the number of vacant seats is one and the time to enter the store is 15 minutes later, the discount rate calculating module 44 calculates 0.2 which is the product of 0.1 and 2.0 and calculates the discount rate as 20%. Further, for example, when the number of vacant seats is three and the time to enter the store is 30 minutes later, the discount rate calculating module 44 calculates 0.3 which is the product of 0.2 and 1.5 and calculates the discount rate as 30%. Further, the discount rate calculating module 44 may calculate the discount rate of the coupon based on either the first discount constant or the second discount constant described above. In this case, the discount rate calculating module 44 may change the discount rate of the coupon according to the detected number of vacant seats or the ratio of vacant seats, or may change the discount rate of the coupon depending on the time it takes for the customer who has been provided with the coupon to enter the store.

A sales forecasting module 45 forecasts the number of vacant seats after a predetermined time in the case of providing the coupon and a sales amount changed by providing the coupon (step S36). In step S36, the sales forecasting module 45 forecasts the sales amount after the predetermined time (in the present embodiment, after 15 minutes, 30 minutes, or 45 minutes). The sales forecasting module 45 forecasts the sales amount changed by providing the coupon, based on a sales amount in a state where the vacant seats exist, the number of vacant seats, the above-described probability that the vacant seat is filled, the calculated discount rate, and a basic charge. The sales amount in the state where the vacant seats exits is a sales amount of the store after the predetermined time in the current state. The number of vacant seats is a number calculated based on the above-described vacant table information. The basic charge is a charge of food ordered by the customer, which is based on the attribute information.

The sales forecasting module 45 calculates the sales amount in the state where the vacant seats exits, by the product of the number of seats in which the customers exist and the basic charge. The sales forecasting module 45 calculates the sales amount due to providing the coupon after the predetermined time, by the product of the number of vacant seats, the probability that the vacant seat is filled, the discount rate, and the basic charge. For example, when one vacant seat currently exists and the coupon is provided after 15 minutes, the sales amount after 15 minutes will increase by 24%. The sales forecasting module 45 calculates the sales amount after the predetermined time, by a sum of the sales amount in the state where the vacant seat exists and the sales amount due to providing the coupon after the predetermined time. The sales forecasting module 45 forecasts the sales amounts for all the predetermined times.

Based on the forecasting result, the sales forecasting module 45 acquires the predetermined time after which the sales amount forecast becomes maximum (step S37). In step S37, for example, in a case where the sales amount forecast becomes the maximum after 15 minutes, this time is acquired.

The discount rate calculating module 44 calculates the discount rate of the coupon to be issued based on the first discount constant and the second discount constant (step S38). In step S38, the discount rate calculating module 44 calculates the discount rate based on the first discount constant corresponding to the detected number of vacant seats and the second discount constant associated with the time at which the sales amount forecast becomes the maximum.

The coupon issuing module 46 issues the coupon in which an effective time and a discount rate are described (step S39). In step S39, the effective time is a time acquired by the process of step S37 described above. The discount rate is a numerical value calculated by the process of step S38 described above.

Further, the coupon issuing module 46 may learn effects of the issued coupons and issue a coupon reflecting the learning result. For example, the sales forecasting module 45 may learn, as teacher data, effective times and discount rates at which the sales amount forecasts become maximum, and the coupon issuing module 46 may issue the coupon describing the effective time and the discount rate which the discount rate calculating module 44 and the sales forecasting module 45 calculate based on the learning result. Further, the coupon issuing module 46 may issue the coupon only in a specific time period. For example, the coupon issuing module 46 may issue the coupon only in a time period in which few customers exist usually.

Further, the computer 10 may link accounting information on the issued coupon with an external accounting system. For example, the computer 10 may cause the external accounting system to calculate sales, profits, and the like occurred by the coupons.

The coupon issuing module 46 creates a coupon acquisition screen describing the URL or the like for accessing the issued coupon (step S40). In step S40, the coupon issuing module 46 creates a notification on the effective time, the discount rate, and the like as the coupon acquisition screen, and creates an icon and the like for receiving an input relating to issuance of the coupon.

The coupon issuing module 46 transmits acquired data indicating the coupon acquisition screen to the customer terminal 200 (step S41). In step S41, the coupon issuing module 46 may provide the acquired data as the Web content, may provide the acquired data from a cooperated SNS, may provide the acquired data as an advertisement medium, or may transmit the acquired data as an email. By transmitting the acquired data to the customer terminal 200, the computer 10 provides the issued coupon based on a request from the customer.

A coupon acquiring module 250 receives the acquired data. A display module 270 displays the coupon acquisition screen based on the received acquired data (step S42).

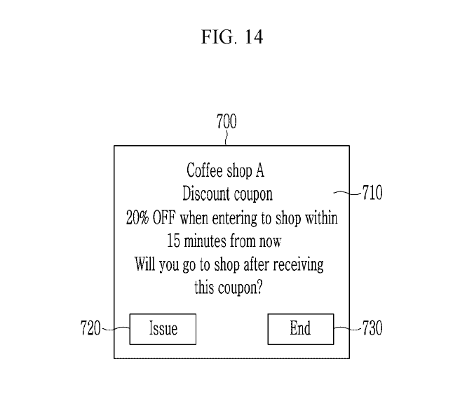

The coupon acquisition screen displayed by the display module 270 is described with reference to FIG. 14. FIG. 14 is a diagram showing an example of the coupon acquisition screen displayed by the display module 270. In FIG. 14, the display module 270 displays a coupon content display area 710, an issue icon 720, and an end icon 730 as the coupon acquisition screen 700. The coupon content display area 710 is an area for displaying a notification indicating that this screen is a screen relating to acquisition of a coupon, a store name, an effective time, and a discount rate. The issue icon 720 is an icon for receiving an input from a customer and acquiring the coupon. The end icon 730 is an icon for receiving an input from the customer and ending the display of this screen.

The coupon content display area 710 may display messages including a description of the store, a vacant seat status, a message such as an SNS of the store, a peripheral map of the store, a location of the store, a link for seat confirmation, a link for introducing other stores, and the like.

The display module 270 determines whether an input for issuing a coupon is received (step S43). In step S43, the display module 270 performs the determination based on whether the input of the issue icon 720 or the end icon 730 is received.

In step S43, upon determining that input for issuing the coupon is not received (NO in step S43), the display module 270 repeats this process. When the display module 270 receives the input of the end icon 730, the display module 270 ends the present process and terminates the display of the coupon acquisition screen 700.

On the other hand, when the display module 270 determines in step S43 that the input for issuing the coupon is received (YES in step S43), the coupon acquisition module 250 acquires the coupon (step S44).

The display module 270 displays the acquired coupon (step S45).

The above is the coupon providing process.

The means and functions described above are realized by reading and executing a predetermined program by a computer (including a CPU, an information processing device, and various terminals). The program is provided, for example, in a form (SaaS: software as a service) provided from the computer via a network. Further, the program is provided, for example, in a form recorded in a computer-readable recording medium such as a flexible disk, a CD (e.g., CD-ROM or the like), a DVD (DVD-ROM, DVD-RAM, or the like), or the like. In this case, the computer reads the program from the recording medium and transfers the program to an internal storage unit or an external storage unit to be stored and executed. Furthermore, the program may be recorded in advance in a storage device (recording medium) such as a magnetic disk, an optical disk, an optical magnetic disk, or the like and be provided from the recording medium to the computer through a communications line.

While the embodiments of the present invention have been described above, the present invention is not limited to the above-described embodiments. In addition, the effects described in the embodiments of the present invention are merely a list of the most preferable effects produced by the present invention, and the effects of the present invention are limited to those described in the embodiments of the present invention.

### DESCRIPTION OF REFERENCE NUMBERS

1: vacant seat detecting system, 10: computer, 100: camera, 200: customer terminal

1. A computer system for detecting vacant seats and providing a coupon, the computer system comprising:
an acquiring unit that acquires a camera image;
a detecting unit that detects vacant seats by performing an image analysis on the acquired camera image;
an issuing unit that issues a coupon based on a result of the detection;
a providing unit that provides the issued coupon; and
a forecasting unit that forecasts a number of vacant seats in each time of a case where the coupon is provided and a sales amount changed by providing the coupon.

2. The computer system according to claim 1, wherein the issuing unit issues the coupon in which a discount rate by the coupon changes according to a number of the vacant seats or a ratio of the vacant seats.

3. The computer system according to claim 1, wherein the issuing unit issues the coupon in which a discount rate by the coupon changes according to a time it takes a customer who has been provided with the coupon enters a store.

4. (canceled)

5. A vacant seat detecting method of detecting a vacant seat and providing a coupon, the method comprising:
acquiring a camera image;
detecting vacant seats by performing an image analysis on the acquired camera image;
issuing a coupon based on a result of the detection;
providing the issued coupon; and
forecasting a number of vacant seats in each time of a case where the coupon is provided and a sales amount changed by providing the coupon.

6. A computer program product for use in a computer system for detecting a vacant seat and providing a coupon, comprising a non-transitory computer usable medium having a set of instructions physically embodied therein, the set of instructions including computer readable program code, which when executed by the system causes a processor to execute:
acquiring a camera image;
detecting vacant seats by performing an image analysis on the acquired camera image;
issuing a coupon based on a result of the detection;
providing the issued coupon; and
forecasting a number of vacant seats in each time of a case where the coupon is provided and a sales amount changed by providing the coupon.
